(19) United States
(12) Patent Application Publication
(10) Pub. No.: US 2004/0083763 A1
(43) Pub. Date: May 6, 2004

(54) Method and device for heating glass sheets in an oven

(76) Inventor: Emmanuel Lambert, Jumet (BE)

Correspondence Address: Piper Rudnick, 1200 Nineteenth Street N W, Washington, DC, 20036-2412, US

(21) Appl. No.: 10/472,386

(22) PCT Filed: Mar. 15, 2002
(86) PCT No.: PCT/EP02/03020

(30) Foreign Application Priority Data
Mar. 23, 2001 (BE) 20010193
Sep. 26, 2001 (BE) 20010621

(51) Int. Cl. C03B 25/08

(52) U.S. Cl. 65/119; 65/111; 65/273; 65/182.2

(57) ABSTRACT

The invention concerns a method and a device for heating glass sheets in an oven, which are transported therein by a conveyor with horizontal rollers and wherein their surfaces are heated by heating means arranged above and beneath the sheets, by radiation and by forced convection by injecting hot gas into the oven, the gas injected beneath being in the form of jets whereof the axis of symmetry is oblique relative to the forward moving direction of the sheets on the conveyor and directed towards their lower surface.

The present invention relates to a method for heating glass sheets in an oven, in particular with a view to a subsequent thermal treatment of such, especially toughening.

The invention also relates to a device for conducting this method.

Ovens for heating glass sheets particularly with a view to subsequently toughening these comprise a roller conveyor, the rollers generally being ceramic-coated, with electrical resistors disposed above and below it for radiation heating of glass sheets transported onto said conveyor. The assembly is positioned in an insulating enclosure. When the resistors are heated, the rollers of the conveyor accumulate heat and by conduction rapidly transfer it to the glass they come into contact with. With equal heating power of the lower and upper resistors, therefore, the lower face of a glass sheet receives a higher quantity of heat per unit time than the upper face. This can lead to concave bending of such a glass sheet in relation to the plane of the conveyor, which possibly causes a deterioration in its surface flatness and also surface flaws as a result of the weight of the glass sheet being concentrated on a reduced portion of the surface of the rollers. Non-uniform heating of the glass sheets may also cause optical distortions of the glass as well as affecting the uniformity of fragmentation once toughened when they are broken.

This phenomenon is further accentuated when the glass sheets heated in the oven are coated with low-emissive (low-e) layers, which in consequence have the property of reflecting a significant portion of the heat radiated by the resistors. The coated face of these sheets is generally the one which does not come into contact with the rollers of the conveyor so that these do not cause deterioration of the coating of these sheets as a result of mechanical contact. Consequently, not only do the rollers of the conveyor supply an additional quantity of heat to that radiated by the lower resistors of the oven to the lower face of the glass sheet, but a substantial part of the heat radiated by the upper resistors does not heat the upper face of the sheets. A significant thermal imbalance results from the combination of these two phenomena causing the glass sheets to bend accordingly in a concave shape and the disadvantages resulting therefrom. Local modifications of the optical properties of the coating layers borne by a glass sheet can result from this, or even burns of this coating. These deteriorations will be further accentuated if an attempt is made to re-establish the surface flatness of the glass by increasing the quantity of heat radiated by the resistors disposed above the conveyor.

A proposal has been made to remedy the aforementioned disadvantages by balancing the temperature profile of the glass sheets conveyed in the oven.

In particular, according to the instruction of U.S. Pat. No. 4,390,359, a device for the injection of hot gas may be provided in the heating oven for this purpose arranged above the upper face of the glass sheets conveyed therein. A transfer of heat by forced convection occurs between the gas jets and the upper face of the sheets, such a transfer being independent of the emissivity of the surface to which the heat is applied. In this case, it is necessary to interrupt the injection of gas during the heating cycle, when the temperature of the glass has increased sufficiently, otherwise convex bending of the sheets may result.

Control of the precise instant when it is necessary to limit the supply of heat by forced convection to the upper face of the glass sheets is a delicate matter and is dependent on several factors such as flow rate and temperature of the gas jets, the number and composition of the rollers of the conveyor, the quantity of glass sheets conveyed into the oven per unit time, which influences the temperature of the rollers. This requires a complex regulation system for the gas injectors to be provided to thus ensure the relevant control.

Instead of increasing the quantity of heat supplied to the upper face of the glass sheets by forced convection, it has also been proposed by patent application WO 97/44283 to reduce the supply of heat to the lower face of the glass sheets using a device for injecting cold gas beneath the conveyor in the direction of the lower face of the glass sheets.

Such a device also poses the problem of control of the supply of cold gas under the glass sheet as it advances through the oven, and therefore also requires the provision of a complex control system for the gas injectors to assure said control. Moreover, cooling of the oven atmosphere is detrimental to the efficient heating of the glass and therefore to the quantity of glass sheets which the oven can treat per unit time.

It has also been proposed in EP 058529 to dispose a device for injecting hot gas perpendicular to the glass sheets beneath the conveyor, said device being actuated when the quantity of heat, which is radiated by the lower resistors to the conveyor and reflected thereby so that it does not reach the lower face of the glass sheets, becomes greater than that transmitted by the rollers to this face by conduction, causing the thermal balance of the transfer of heat to the faces of the sheets to become unfavourable to their lower face. The device according to EP 058529 is actuated with a view to re-establishing the surface flatness of the glass sheets. However, because the direction of the gas jets is perpendicular to the lower face of the glass sheets, such a device means that the rate of forced convection applied to this face remains essentially constant irrespective of the flatness of said sheets. Consequently, when the supply of heat to the sheets at their upper face remote from the conveyor is excessive such that it causes convex bending of said sheets, the excess in question is not compensated by a corresponding increase in the rate of forced convection applied to the lower face of the sheets. This thermal imbalance is further reinforced by the fact that when a glass sheet is bent in a convex shape above the conveyor, the rollers thereof no longer supply heat by conduction to the lower face of the sheet since contact between them and said rollers is interrupted over the major portion of the face in question.

The present invention aims to resolve the problems of controlling the stability of the surface flatness of glass sheets in an oven for heating said sheets, in particular with a view to a subsequent thermal treatment thereof, by proposing a method for heating glass sheets in an oven, wherein the glass sheets are transported by a conveyor with essentially horizontal rollers through said oven, where the faces of a glass sheet are heated by radiation heating means, e.g. electrical or equivalent resistors, disposed above and beneath said sheet, and in which said faces are subjected to an effect of forced convection of heat by the injection of hot gas into the oven above and beneath said glass sheets, wherein the gas is injected beneath a glass sheet in the form of jets, the axis of symmetry of which is oblique relative to the direction of travel of a glass sheet on the conveyor and directed towards the lower face of said sheet.

The term oblique relates to any inclination of at least five degrees relative to the vertical.

The invention also relates to a device for heating glass sheets in an oven comprising a conveyor with essentially horizontal rollers, radiation heating means disposed above and beneath the conveyor, hot gas injectors also disposed beneath and above the conveyor and means for feeding gas to the injectors, wherein those injectors disposed under the conveyor are oriented such that their axis of symmetry is oblique in relation to the direction of travel of a glass sheet on the conveyor.

The injection of hot gas in the form of oblique jets directed towards the lower face of a glass sheet enables the rate of forced convection at the level of this face to increase markedly when the sheet is bent in a convex shape above the conveyor when the supply of heat to the upper face of said sheet becomes greater than that applied to the lower face of this sheet.

In fact, so long as the sheet is flat on the rollers of the conveyor, each jet of hot gas only substantially affects the portion of glass surface located between two rollers. On the other hand, as soon as the sheet is bent above the conveyor, each jet of hot gas affects a much larger portion of the surface of this sheet because of its oblique direction relative to the sheet, thus proportionally increasing the rate of forced convection of heat at the level of the lower face of the glass sheet.

This is not the case when the jets of gas are directed perpendicularly to said face, since when the sheet bends above the conveyor the portion of its surface affected by each jet of gas is not substantially modified.

The increase in the rate of forced convection at the level of the lower face of a glass sheet permitted by the invention causes the deflection of said sheet to be practically eliminated, and consequently allows the surface flatness of the latter on the conveyor to be stabilised. In fact, the mentioned increase will be repeated each time the glass sheet bends above the conveyor. Normally, the pressure of the hot gas in the feed means of the lower injectors to the conveyor still remains appreciably less than the pressure of the hot gas in the feed means of the upper injectors to the conveyor such that the heat supplied by the injected gas beneath the conveyor to the level of the lower face of a glass sheet can not cause an imbalance to the benefit of the lower face, which could cause this sheet to be bent in a concave shape above the conveyor.

Consequently, the invention also relates to the use of the heating device described above with a view to stabilising the surface flatness of glass sheets in an oven for heating said sheets, in particular glass sheets having a coating of layers of the low-emissive type.

The hot gas injected into the oven may have been reheated from the ambient temperature on entering the feed means of the injectors during its passage in these means to the injectors, said means themselves being heated by the electrical resistors disposed in the oven. Alternatively, the gas can be heated outside the oven before being fed into the feed means of the injectors. Whatever the case, it is preferred that the gas injected into the oven is brought to a temperature greater than 400° C.

Preferably, the injection of hot gas beneath the conveyor is not actuated when the sheet enters the oven. Consequently, it is preferred that the pipes for feeding hot gas to the injectors disposed beneath the conveyor are controlled separately, e.g. by means of valves for opening and closing these. In this way, the lower face of said sheet is firstly only heated by the heat radiated by the resistors disposed beneath the conveyor as well as by that conducted by the rollers, while the upper face of the sheet is also heated by the heat radiated by the resistors disposed above the conveyor as well as by forced convection by means of jets of hot gas directed towards said face. This prevents the glass sheet from bending in a concave shape above the conveyor. When the thermal balance of the heat supplied to each face of the sheet becomes unfavourable to its lower face and when the sheet bends in a convex shape above the conveyor as a result, the injection of hot gas in the form of oblique jets directed towards the lower face of the sheet is actuated and can be maintained for the entire or part of the passage of the sheet in the oven.

On this basis, the invention provides a self-regulation system of the surface flatness of glass sheets conveyed in an oven for heating said sheets. Therefore, it is not necessary to regulate the injection of hot gas in the form of oblique jets directed towards the lower face of a glass sheet according to the invention once it has been actuated.

It is also preferable if the control device of each pipe for feeding hot gas to injectors disposed beneath the conveyor permits modulation of the pressure of said gas as a function of the thickness of the glass sheets conveyed in the oven as well as the emissivity of the coating they bear. In this way, the stabilisation of the surface flatness of the sheets could be optimised as a function of their characteristics.

According to a preferred form of the invention, actuation of the injection of hot gas beneath the conveyor can be controlled by a system for detecting the deflection of the glass sheet above the conveyor or by a timer system.

It is preferred that the axis of symmetry of the jets of gas directed towards the lower face of a glass sheet according to the invention intersects the plane of the lower face of a glass sheet on the conveyor beyond the centre of the space separating the axes of symmetry of two successive rollers. In this way, with an equal distance between the injectors and the rollers, the angle formed by the oblique gas jets and the lower face of a glass sheet is more acute, and this benefits a good flow of gas to the surface of the sheet when it bends above the conveyor.

The feed means for compressed gas of the device according to the invention preferably comprise ducts arranged essentially parallel to the axes of the rollers of the conveyor, on which the injectors are mounted. Such a configuration allows all the injectors disposed on one duct to be controlled simultaneously by means of a single valve for opening and closing this duct.

It is preferred if each of the injectors disposed under the conveyor is located under a roller of said conveyor. In this way, in the event of breakage of a glass sheet on the conveyor, these means do not hinder the glass fragments dropping between the rollers and cannot be damaged, nor can the injectors they carry be obstructed by these fragments.

In addition, it is preferred if the injectors disposed under a roller of the conveyor are oriented such that their axis of symmetry intersects the plane of the lower face of a glass sheet on the conveyor beyond the centre of the space separating the axes of symmetry of two successive rollers of said conveyor.

It is further preferred that said feed means are disposed beneath one roller of at least two. Such spacing is beneficial for a favourable circulation of the gas under the glass sheet when this bends above the conveyor.

According to another preferred arrangement of the invention, the pressure of the gas measured at the end of a pipe for feeding hot gas to the injectors disposed under a glass sheet is in the range of between 0.15 and 10 bar, preferably between 0.2 and 6 bar, and most preferred between 0.25 and 3.5 bar. It is also preferred if these injectors are aligned parallel to the axes of the rollers and separated by a distance in the range of between 40 and 200 mm, preferably between 130 and 170 mm. It is additionally preferred if said injectors are separated from said sheet at a distance in the range of between 25 and 300 mm, preferably between 80 and 160 mm, and more preferred between 90 and 140 mm.

Such pressures and distances are the optimum for the benefit of a good transfer of heat between the gas and the glass sheet while preventing excessive turbulences from occurring in the gas jets at the level of the faces of the glass sheets which could be detrimental to the uniform heating of the glass.

For similar reasons, it is preferred that the section of each injector disposed beneath a glass sheet is less than 1.5 mm² in area. The shape of the outlet section of said injectors is adapted to the geometry of each oven with a view to optimising the heat exchange with the glass when the sheet bends above the conveyor. The shape will generally be circular or oval, but other shapes are also possible according to the invention.

According to another arrangement of the invention, the injectors are controlled so that they only release hot gas at the positions where a glass sheet is present, and this generally corresponds to about ⅔ of the length of the oven. This arrangement of the invention can have the advantage of reducing the energy cost of the operation and can also enable the temperature in the various parts of the oven to be controlled more readily, inter alia those where a glass sheet is present and those where there is none.

In another variant of the invention, the pipes for feeding gas to the injectors supply a pressure and/or a hot gas flow which is not equal over the whole width of the oven, the central injectors having a pressure and/or a flow that is higher than those at the ends. This special feature can facilitate a uniform heating of the glass sheets, their edges at times requiring less heat than their central section to reach an equivalent state. In fact, the edges of the glass sheets present 3 faces to the ambient hot air and can thus reach the desired state more easily than the central section which presents only two faces.

The invention will now be described in more detail by means of the attached drawings, wherein:

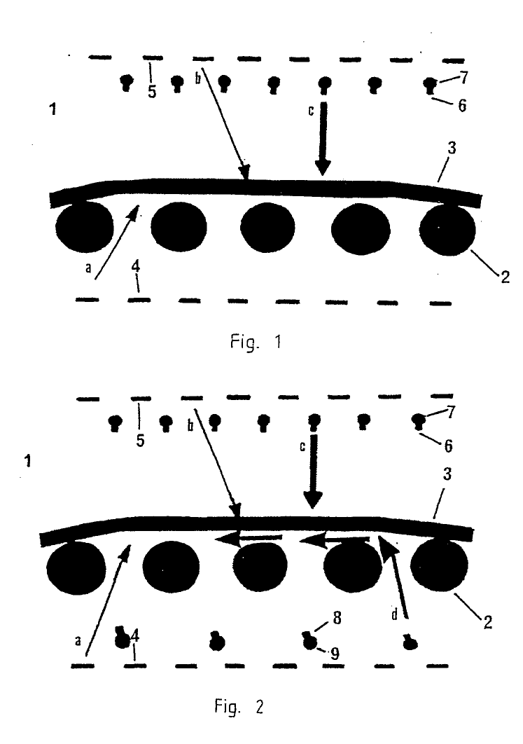

FIG. 1 is a schematic representation in a longitudinal section of a device for heating glass sheets according to the prior art.

FIG. 2 is a schematic representation in a longitudinal section of a device for heating glass sheets according to the invention, viewed at the instant of actuation of the forced convection system disposed beneath the conveyor.

According to FIG. 1, a conveyor (1) comprising rollers (2) is disposed in the enclosure (not shown) of an oven for heating glass sheets. The conveyor (1) carries a glass sheet (3), the lower face of which is subjected to a supply of heat by radiation represented by the arrow (a) by means of electrical resistors (4) disposed beneath the conveyor (1) and by conduction by means of the rollers (2) which have accumulated heat radiated by the resistors (4) and transfer it to the sheet (3). The upper face of the latter is subjected to a supply of heat by radiation represented by the arrow (b) by means of electrical resistors (5) disposed above the conveyor (1) and by forced convection represented by the arrow (c) by means of hot gas injected into the enclosure in the direction of the upper face of the sheet (3) by injectors (6) connected to a feed pipe for hot gas (7) disposed above the conveyor (2) and connected in turn to a compressor (not shown). Under the effect of a supply of heat at the level of its upper face which is greater than that to which its lower face is subjected, the sheet (3) bends in a convex shape above the conveyor (1) and this bending is maintained during the remaining duration of the heating cycle of the glass.

FIG. 2 retains the elements of FIG. 1 with the same references. According to the invention, when the sheet (3) bends in a convex shape above the conveyor (2), the lower face of said sheet is subjected to a supply of heat by forced convection represented by arrows (d) by means of hot gas injected into the enclosure obliquely towards the lower face of the sheet (3) by injectors (8) connected to a pipe for feeding hot gas (9) disposed beneath the conveyor and connected in turn to a compressor (not shown). The injectors (8) are supplied with hot compressed gas when the sheet (3) bends in a convex shape above the conveyor and the supply of heat by forced convection at the level of the lower face of the sheet (3) enables this to recover its surface flatness by balancing the supply of heat at the level of the lower and upper faces of said sheet.

The invention may be illustrated by the following practical example:

In an oven for heating glass sheets comprising a roller conveyor glass sheets are conveyed with a view to subjecting them to a heat treatment prior to a subsequent step of toughening or bending. Said oven is fitted with electrical resistors disposed above and beneath the conveyor so as to establish a temperature in the oven of 700° C. above the conveyor and 690° C. beneath the conveyor. The oven is also equipped with pipes for feeding hot air from injectors of this gas towards the conveyed glass sheet, which are disposed parallel to one another and to the glass sheet and orthogonally to the direction of travel of said sheet in the oven. There are 9 of these pipes above the conveyor and 5 below it. Each upper pipe is separated from the adjacent pipe by a distance of 550 mm and each lower pipe is disposed beneath one roller in 8. Each of the pipes is fitted with 45 equidistant injectors with an outlet section of 0.7 mm, and this section is separated from the glass sheet by a distance of 150 mm. The upper injectors are disposed such that their axis of symmetry is orthogonal to the plane of the upper face of a glass sheet and the lower jets are disposed such that their axis of symmetry is oblique in relation to the direction of travel of the glass sheets in the oven and intersects the plane of the lower face of these sheets to three-quarters of the space separating the axes of two successive rollers. The feed pipes comprise a tube with an inside diameter of 50 mm and are themselves each supplied with air by a coil 12 in length and 15 mm in diameter which is wound around the pipe. The temperature of the air inside the pipes is thus maintained at 670° C. in the case of a continuous injection of air into the oven, the pressure of the air supply to the pipes being adjustable.

A 6 mm thick glass sheet having a coating of layers providing it with an emissivity of 0.03 is conveyed into the oven, wherein the upper feed pipes of the injectors are subjected to an air pressure of 6 bar and the lower pipes are not supplied with air. After it has been inside the oven for 60 seconds, the glass sheet curves in a convex shape above the conveyor and remains thus deformed until the end of the heating cycle, i.e. 310 seconds after the sheet entered the oven. This deflection of the sheet causes surface irregularities as a result of boundary sections of the sheet abutting against the rollers, a deterioration in the optical properties of the coating borne by this sheet as a result of the uneven distribution of heat on the surface of said coating and irregular fragmentation of this sheet during a break test after toughening.

Another glass sheet with identical characteristics to the preceding sheet is fed into the oven and the lower pipes for feeding hot gas to the injectors are supplied with air at a pressure of 1 bar. No further significant deformation of the glass sheet is now observed during the remainder of the heating cycle of said sheet. The faults that appeared when there was no supply from the lower pipes were not observed.

The invention also permits a reduction in the time of the heating cycle of the glass sheets which do not bear any low-emissive coating without this reduction being achieved at the cost of the above-mentioned faults, allowing the supply of heat by forced convection to the upper face of a glass sheet to be increased in relation to that allowed in an oven which does not include the forced convection device according to the invention, this increase being compensated as a result of said device. Hence, the duration of a heating cycle of clear 6 mm thick glass sheets can be brought from 260 to 210 seconds, which is a gain in the order of 20%.

1. Method for heating glass sheets in an oven, wherein the glass sheets are transported by a conveyor with essentially horizontal rollers through said oven, where the faces of a glass sheet are heated by radiation heating means disposed above and beneath said sheet, and in which said faces are subjected to an effect of forced convection of heat by the injection of hot gas into the oven above and beneath one of said glass sheets, characterised in that the gas is injected beneath one of said glass sheets in the form of jets, the axis of symmetry of which is oblique relative to the direction of travel of a glass sheet on the conveyor and directed towards the lower face of said sheet.

2. Method according to claim 1, wherein the axis of symmetry of said jets intersects the plane of the lower face of a glass sheet on the conveyor beyond the centre of the space separating the axes of symmetry of two successive rollers of said conveyor.

3. Device for heating glass sheets in an oven comprising a conveyor with essentially horizontal rollers, radiation heating means disposed above and beneath the conveyor, hot gas injectors disposed beneath and above the conveyor and means for feeding gas to the injectors, characterised in that those injectors disposed under the conveyor are oriented such that their axis of symmetry is oblique in relation to the direction of travel of a glass sheet on the conveyor.

4. Device according to claim 3, wherein the means of feeding hot gas comprise ducts arranged essentially parallel to the axes of the rollers of the conveyor, on which the injectors are mounted.

5. Device according to one of claims 3 or 4, wherein each of the injectors disposed under the conveyor is located under a roller of the conveyor.

6. Device according to claim 5, wherein the injectors are oriented such that their axis of symmetry intersects the plane of the lower face of a glass sheet on the conveyor beyond the centre of the space separating the axes of symmetry of two successive rollers of said conveyor.

7. Device according to claim 5 or 6, wherein said injectors are disposed under one roller of at least two.

8. Device according to one of claims 3 to 7, wherein the pressure of the gas emitted through the injectors disposed under a glass sheet is in the range of between 0.15 and 10 bar, preferably between 0.2 and 6 bar, and most preferred between 0.25 and 3.5 bar.

9. Device according to one of claims 3 to 8, wherein the injectors disposed under a glass sheet are aligned parallel to the axes of the rollers and separated by a distance of between 100 and 200 mm, preferably between 130 and 170 mm.

10. Device according to one of claims 3 to 9, wherein the injectors disposed under a glass sheet are separated from said sheet at a distance of between 25 and 300 mm, preferably between 80 and 160 mm, and most preferred between 90 and 140 mm.

11. Device according to any one of claims 3 to 10, wherein the injectors disposed under a glass sheet are oriented so as to produce jets of gas directed beyond the centre of the space separating two rollers of the conveyor.

12. Device according to any one of claims 3 to 11, wherein the injectors disposed above a glass sheet are oriented so as to emit jets of gas which are essentially perpendicular to said sheet.

13. Device according to any one of claims 3 to 12, wherein the injectors are capable of being controlled so that they only release hot gas at the positions where a glass sheet is present.

14. Device according to any one of claims 3 to 13, wherein the means for feeding gas to the injectors and/or the injectors are adapted to supply a pressure and/or a flow rate of hot gas which is not equal over the entire width of the oven, the central injectors having a pressure and/or a flow rate higher than those at the ends.

15. Use of the device according to one of claims 3 to 15 with a view to stabilising the surface flatness of glass sheets in an oven for heating said sheets.

16. Use of the device according to claim 15 with a view to stabilising the flatness of the surface of glass sheets with a low-emissive coating.
